(19) United States
(12) Patent Application Publication
(10) Pub. No.: US 2022/0289550 A1
(43) Pub. Date: Sep. 15, 2022

(54) A Beverage Dispense Apparatus and Method Relating to Same

(71) Applicant: Diageo Ireland Unlimited Company, Dublin 8 (IE)

(72) Inventors: Christopher Murphy, Summerhill, Co. Meath (IE); Stephen Hendron, Swansea West Glamorgan (GB); Stephen Kilcullen, Leixlip, Co. Kildare (IE); James Ryan, Dublin 6 (IE)

(21) Appl. No.: 17/633,691

(22) PCT Filed: Aug. 21, 2020
(86) PCT No.: PCT/EP2020/073552

§ 371 Date: Feb. 8, 2022

(30) Foreign Application Priority Data
Aug. 22, 2019 (GB) 1912089.8

(51) Int. Cl. B67D 1/06; B67D 1/04; B67D 1/08

(52) U.S. Cl. CPC B67D 1/06; B67D 1/0425; B67D 1/0894; B67D 1/0891; B67D 2001/0098

(57) ABSTRACT

An apparatus (10) and method for dispensing beverage from a single serve beverage package (b), e.g. an aluminium can B. In operation the sealed package (B) is located and held in a receiving enclosure (11) where, firstly, a dispense end of the package is opened by a piercing element (24) and, secondly, a gas is introduced under pressure at a second end through a hollow needle (19). Gas from a pump, into the internal volume of package (B), is then used to drive beverage from the beverage package, e.g. through a restrictor structure (27), at the dispense end and into a drinking vessel (G). The pump mode may then apply negative pressure to prevent flow and enable a pause in flow or at completion of delivery to a vessel (G).

### TECHNICAL FIELD

The present invention relates to a method and apparatus for beverage dispense. The method and apparatus replicates draught dispense in a compact device and in one form enables forming of a head on the beverage during/following the dispense process. Such a beverage will have gas in solution such as carbon dioxide, nitrogen, a combination thereof or any other inert gas suitable for the purpose. The beverage may be alcoholic or non-alcoholic, but the present invention is particularly suited for use with beverages such as cider, cocktails, beer, lager, ale and stout, where the presence of a head on the beverage when it is presented to the consumer in a drinking vessel is traditional and desirable.

### BACKGROUND TO THE INVENTION

The most common form of beer delivery to a consumer is by way of a draught dispenser from a keg (i.e. a large volume/bulk container with multiple servings) or single unit packages such as aluminium cans and glass bottles. Draught dispense is generally only possible in a public house/restaurant environment since dispense equipment is expensive and requires maintenance. Of course, it is not always possible for a bar or similar outlet to store beverages in bulk containers such as kegs, due to space and cost constraints. The space needed to store kegs is significant, and the associated dispensing and chilling equipment also involves significant cost for the proprietor and may not be justified where there is a relatively low volume of sales. Many establishments therefore concentrate on selling beverages stored in bottles or cans, which are usually kept in display fridges behind the bar. Single unit packages are also commonly available for home use.

Draught dispensers rely on gas under pressure to deliver beverage from the keg to a drinking vessel such as a pint glass. Gas pressure can be further utilised to force the beverage through a multi-aperture “creamer plate” which encourages dissolved gas out of solution and, particularly in connection with nitrogenated beers, results in a creamy head being produced in the glass for serving. A creamer plate is not desirable in the context of a lager or other purely carbonated beverage because it causes excessive frothing and a head which is too large and obstructive for comfortable consumption.

Use of conventional single unit packaging cannot reproduce the head of a draught dispense system unless an additional device/feature is employed to mimic the effect. A common device used for mimicking a draught pour head is a so-called “widget”, being a hollow plastic device inserted into the can or bottle during filling, to float on the surface of the beverage of a sealed can. An internal volume of the widget is pressurised during the filling process and, upon opening the beverage package, a pressure differential causes a jet of gas/beverage to be released into the main volume of beverage, triggering nucleation of the dissolved gas to bubble out of solution.

Widgets are widely available and accepted in the marketplace but add an expense/delay to the manufacturing process along with resultant plastic waste as the widget is left behind in a used beverage container.

Alternative single serve head producing methods are known. For example, ultrasonic excitation can produce or increase a head on a beverage. The ultrasonic excitation causes cavitation of the liquid which encourages the gas in the liquid to come out of solution. The gas thus forms as tiny bubbles which migrate to the surface of the liquid, forming a head of froth on the surface. The equipment required is relatively straightforward and does not require much space, and therefore is suitable for use in establishments of the type discussed above which stock only bottled or canned beverages and which may have space constraints.

Dispense systems that utilise compressed air to assisting emptying a unit-serve are also known, e.g. WO2017/121796 and WO2019/101997. However, such systems relate to a beverage preparation machine where a beverage concentrate from a pierced container is mixed with a diluent from another source, e.g. a predetermined amount of carbonated water, and subsequently delivered to a drinking vessel by assistance of a compressed air source. The use of compressed air also has the effect that back-contamination in the direction of the dispenser is effectively avoided because a pressure duct is immediately under pressure when the cartridge system is inserted into the holder and thus foodstuff substrate and/or beverage substrate is prevented from travelling in the direction of the dispenser and compressed air source. The application of these systems is quite different to the context of the present invention.

WO2009/024147 relates to a beverage distribution system where a multi-serve deformable and replaceable container is housed within a pressurisable chamber. Compressed air introduced into the chamber causes deformation of the container and forces its contents, e.g. beer, through an outlet for dispense. This system, being based on a multiple serve container and configured for pressurising the outer walls of a deformable container (i.e. where the pressurised fluid is not in direct contact with the beverage itself) is, again, quite different to the context of the present invention.

U.S. Pat. No. 3,424,346 discloses a dispenser where multiple beverage packs are loaded into the device. As a lid is closed puncturing tips engage the packs, venting to a passage.

### SUMMARY OF THE INVENTION

The present invention seeks to provide an alternative apparatus, method and system of beverage dispense for single serve volumes to a consumer. Single serve refers to a canned or bottled product, as distinct from a kegged beverage. The invention at least presents a useful alternative to replicate draught dispense in a compact device.

In a broad aspect the apparatus of the invention is defined according to claim 1. A method according to the invention is defined at claim 18.

It is envisaged that the invention will provide an improved method and apparatus for forming a head on a beverage and/or, indeed, a general novel dispense system replicating draught dispense in a compact device not necessarily applied only to beverages requiring head formation. Particularly, the apparatus should be simple to use and does not require the user to perform multiple operations or, at least, minimises maintenance operations. The user may therefore be relatively unskilled and the process easily repeatable to ensure a consistent quality of serve.

The invention may take the form of a beverage dispense apparatus comprising a receiving feature or means, e.g. a cradle/holder/support/frame, for locating and supporting (i.e. ensconcing/enclosing) opposite ends of a beverage package, e.g. in an inverted configuration. In one form the receiving structure is configured to locate the beverage package above a delivery vessel, such that gravity assists dispense into said vessel or at least use of a pump during all or part of the dispense is not necessary. The beverage package is likely a single serve volume for convenience and hygiene reasons, however, it is possible that either a limited number of multiple serves could be dispensed from the package dependent on its internal volume, or multiple single serve packages can be lined up in series for dispense. Once the package is secured at both ends by the receiving feature a gas delivery means/mechanism/device is configured to introduce a gas under pressure into the beverage package, i.e. into direct contact with the internal volume of liquid. In practice the gas delivery means may be in the form of or include a puncturing device/cannula/hollow needle type device, associated with a piston or like engagement surface pushing against an end of the beverage package, and driven through a wall of the package, e.g. the upturned end wall. By way of example, gas may be delivered from an ambient air compressor or bottled. Preferably, while the gas is introduced into the package and in direct contact with the beverage, the delivery point is above the level of the beverage, i.e. so it does not bubble through the liquid or need a long snorkel. Gas may be driven by a pump (which may be switched to operate in different modes) or a plurality of pumps. In a particular form of the invention the gas delivery means is operable to create a vacuum for improved control, e.g. pause, of beverage dispense. A vacuum applied when dispense into the vessel is complete is also useful to prevent significant dripping into the head of the beverage for presentation purposes.

The invention optimises dispense from a single serve container of a ready-to-consume beverage by use of compressed air as the compellent. In this context “ready-to-consume” simply means drinkable in that state and where there is no mixing with another liquid prior to dispensing. In practice the beverage package may contain a stout beer with gas in solution which, preferably, requires one further step of foam formation to render the beverage most desirable for consumption. The package requires a dispense outlet for enabling egress of beverage. The dispense outlet may be incorporated with (or removable from) a housing or frame associated with the receiving features. The dispense outlet includes a nozzle and a means of puncturing a dispense end of the beverage package, e.g. before gas is introduced into an internal volume of the package from the gas delivery means. In other words, there are two puncturing operations relative to the beverage container, namely a first puncturing step to open an outlet and a second puncturing step to open an access into a head space of the container and subsequently introduce a pressurisable fluid that will assist the beverage through the outlet. In a board aspect the invention requires a beverage package to be held between its two ends. Each end is engaged with an engagement portion having a puncturing element and timed such that the lowermost end is punctured first, initiating liquid flow, before an uppermost end is punctured whereat a gas may be delivered to pressurise the headspace.

In one form the first point of puncturing is substantially distant from the second point of puncturing, e.g. at opposite ends of a beverage container. “Distant” should at least be interpreted as the gas pressure source outlet not being at the same end as the liquid beverage outlet where, otherwise, the introduction of compressed air at a submerged outlet would bubble up through the container.

In one form the outlet puncturing means is a hollow element through which flows the ready-to-consume beverage during dispense toward a drinking vessel located closely adjacent thereto. In a form of the invention configured for encouraging a head to form on the poured beverage, the dispense outlet includes a restrictor (aperture) plate to encourage gas out of solution when beverage is forced therethrough. The compressed air used as compellent in the invention generates the velocity required to cause bubble nucleation as it passes through the restrictor aperture. The use of compressed air also assists in pushing beverage out of the container. A back pressure (vacuum) may assist in controlling beverage flow, particularly for a “two-part” pour required for some beverage products and/or at the end of pour.

It will be apparent that the exemplary form of the invention features the gas delivery means separate from the dispense end, i.e. it is located distantly, at an opposite end of the container or at least spaced apart thereabout. In practice there will be two piercing elements, a first which opens a dispense end of the beverage container and a second which introduces compressed gas to drive liquid from the container and through the dispense end (which is preferably a hollow outlet coaxial with the puncturing element), e.g. while passing through a restrictor plate.

The receiving structure, feature or means, or general enclosure of the apparatus, includes a means of clamping/holding the opposite ends of the package in place, e.g. prior to and in preparation for introduction of the dispense and gas delivery means. Such a clamp may include a mechanical actuator, e.g. one or a pair of actuators or a piston that applies force to an upper end of the package. In use, the receiving structure preferably suspends the beverage package over a vessel to be filled, e.g. a glass, so that beverage can flow with the assistance of gravity or without a pump.

As mentioned, the beverage package is preferably a single serve/unit that in a conventional sense is turned upside down (i.e. inverted) for installation into the apparatus. External printing on the package may be correspondingly “upside down” so that the end/dispense end is the “base” of the pack. However, inversion is not essential as openings can be driven through a package wall regardless of orientation in further embodiments.

The apparatus includes a means of controlling/automating timing of package puncture sequence once the beverage package is secured in place. The control means may be electronic and/or mechanical in nature. An example of mechanical form may feature resilient bushes (e.g. compressible material and/or springs) located against opposite end surfaces of the package that (in use) may provide a sequencing function, e.g. to ensure that a dispense opening is first formed through a package wall before introduction of the gas deliver means at the other end. Bushes, e.g. arranged coaxially along a longitudinal axis of the package, may have different deformation properties. An example of electronic engagement may include a motorised actuator at each end, where a dispense end puncturing device is driven by a motor, followed by a gas delivery puncturing device driven by another motor. Equivalent variations will be apparent to a skilled person.

A method of dispensing beverage from a beverage package according to the invention includes the steps of locating and holding a sealed beverage package by its opposite ends in a receiving device, opening a dispense end of the beverage package, introducing a gas under pressure into the beverage package at a location distant from the dispense end and dispensing beverage from the beverage package, through the open dispense end, into a vessel.

Dispense speed may be controlled by gas pressure of the delivery device. Indeed, dispense may be stopped/paused in order to allow a settle time of the beverage before restarting dispense and delivering a final volume. Such control may be achieved by used of a vacuum configured pump. A vacuum step may also be applied at completion of filling a vessel to preserve the quality of the head.

### BRIEF DESCRIPTION OF THE DRAWINGS

FIG. 1 illustrates a elevation/section view of an embodiment of the present invention;

FIG. 2 illustrates a detailed section view of an embodiment;

FIG. 3 illustrates a first sequence of operational steps for the embodiment of the present invention shown in FIG. 2;

FIG. 4 illustrates a first series of a supplementary filling sequence;

FIG. 5 illustrates a second series of the supplementary filling sequence;

FIG. 6 illustrates an elevation external view of the present invention, including a cradle for tilting a glass.

### DETAILED DESCRIPTION OF THE INVENTION

The following description presents exemplary embodiments and, together with the drawings, serves to explain principles of the invention. However, the scope of the invention is not intended to be limited to the precise details of the embodiments, since variations will be apparent to a skilled person and are deemed also to be covered by the description. Terms for components used herein should be given a broad interpretation that also encompasses equivalent functions and features. In some cases, several alternative terms (synonyms) for structural features have been provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “upper” and “lower” are used for convenience of explanation usually with reference to the illustrations and are not intended to be ultimately limiting if an equivalent function can be achieved with an alternative dimension and/or direction.

The description herein refers to embodiments with particular combinations of features, however, it is envisaged that further combinations and cross-combinations of compatible features between embodiments will be possible. Indeed, isolated features may function independently as an invention from other features and not necessarily require implementation as a complete combination.

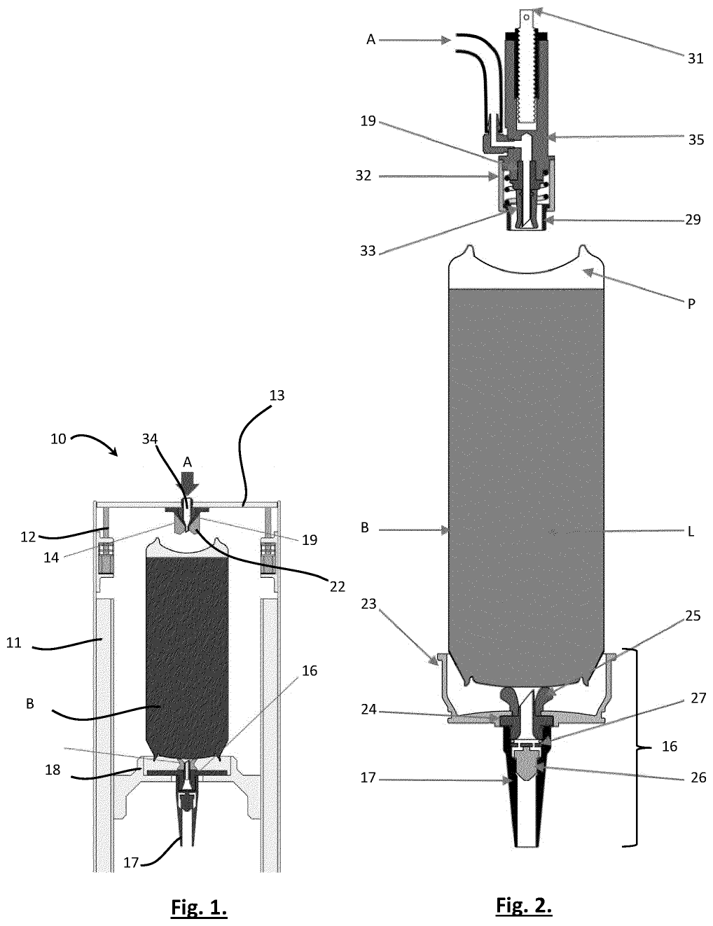

Referring to FIG. 1, an apparatus 10 is illustrated, suitable for implementing a method and providing an example according to the invention. The beverage dispense apparatus 10 includes a main frame 11 supporting a linear actuator 12 to operate a clamp/piston portion 13 that functions to bring an engagement portion 14 against the base of an inverted beverage container B (e.g. an aluminium can) held within the apparatus (e.g. by a receiving means/sleeve). The beverage container B or apparatus further includes a closure component 16, including an outlet nozzle 17 accommodated by an annular mounting 18 associated with the frame 11. At an upper end of the apparatus, a cannula or hollow needle 19 is provided for movement with platform 13 (or piston equivalent), in use, toward and away from the up-ended base of beverage container B.

The apparatus 10 may be operated by manual (e.g. by pulling a lever) or electronic means, engaging linear actuator 12 and causing a downward movement of platform 13 toward beverage container B. Engagement portion 14 serves to locate, via a convex contacting face 22 with the concave base of inverted can B.

Not shown in FIG. 1 is a conduit communicating compressed air to, in use, enter a channel 34 through platform 13 and subsequently through hollow needle 19. Compressed air, introduced as indicated by directional arrow A, is intended to be generated from a low-cost compressor pump (or plural pumps) supplied with the dispense device (not illustrated). Advantageously, the device can operate with compressed ambient air, rather than necessarily bottled gas, without the adverse effect of spoiling the beverage (e.g. via oxidation) since the context of the invention requires the gas to be introduced into and in contact with a single serve volume, as opposed to a multiple serve keg (20-50 L volume) where the beverage contents should be kept isolated from oxygen in the atmosphere.

Closure end 16 may be a low-cost consumable injection moulded component clipped onto a can end after it is sealed in a factory to ensure the device stays free of used liquid and hygienic. The closure may include a peel-away seal arranged over the closure, where nozzle 17 would be flexible/stowable underneath said seal and against closure 16, awaiting use. However, in the illustrated forms, the closure/nozzle is intended to be a feature of the apparatus, rather than a disposable piece shipped with the beverage container.

FIG. 1 illustrates a general configuration common to all embodiments, where a receiving structure supports a beverage package in an upright position that, in use, is directly above and in line with a vessel to be filled. When a dispense end of the package is opened, beverage initially flows under gravity. An alternative form of the invention may allow a conduit to deliver beverage from the dispense end to a location out of line with the beverage package, e.g. a bar top tap.

FIG. 2 shows details of the closure end 16 including a collar portion 23, a piercing element 24 for contacting with and puncturing beverage container B, a deformable structure 25 that enables reciprocating movement of the piercing element 24 during compression. A restrictor structure 27 arranged at an inlet end of nozzle 17 features a series of small holes to restrict flow and encourage nitrogen bubble release from the liquid as it passes therethrough and into a secondary vessel for serving. Downstream of restrictor 27 a baffle 26 provides a flow straightening function.

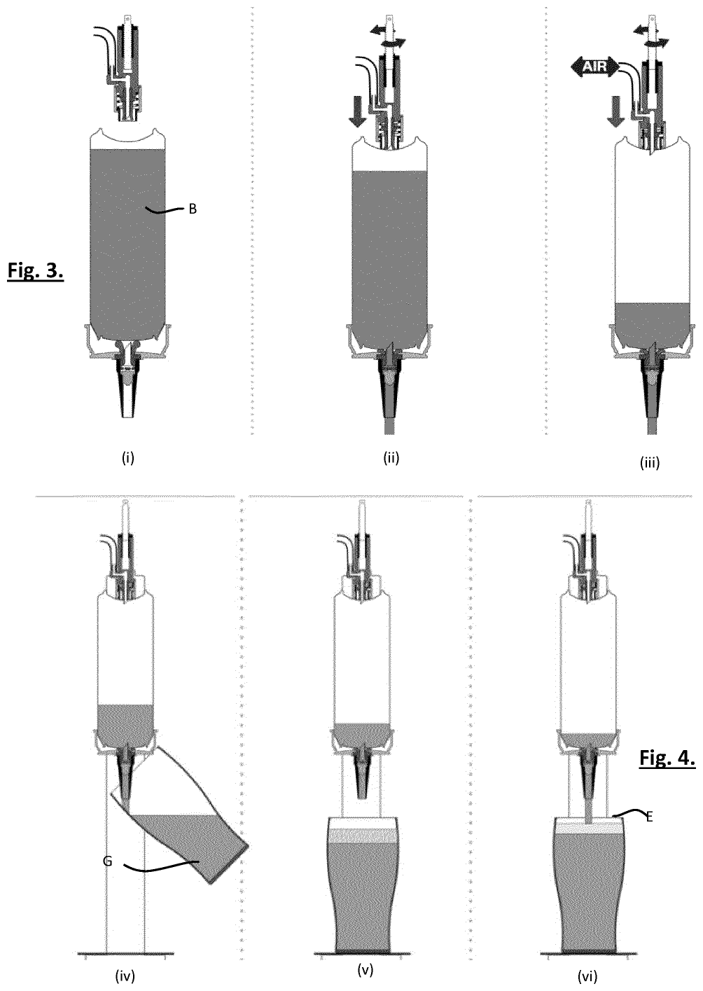

FIG. 3 illustrates an operating sequence consisting of three main steps, indicated by Roman numerals (i), (ii) and (iii).

The first step (i) involves inserting an inverted beverage package, e.g. a container B in the form of a single serve aluminium can, into the device to be received by collar 23 against deformable structure 25. The can B rests on the lower cannula seal (25) under gravity without substantive deformation. A receiving structure (only partially visible) holds both ends of the single serve can in place, prior to engagement of dispense piercing means.

The second step (ii) involves activating the upper platform 13 and associated engagement means to engage and seal a deformable bushing 14 against container B, wherein continued downward force presses dispense end 16 of container B downwards against deformable structure 25, thereby engaging piercing element/cannula 24 and piercing container B at its lowermost end proximate closure 16. At this stage liquid flow is initiated through nozzle 17 directly into a secondary vessel, e.g. a glass G (shown in FIGS. 4 to 6) located closely below. Particularly, an actuator drives upper moving clamp downward causing spring loaded cylinder 29 to apply force to the uppermost end of the can B. Can B is forced downward overcoming resistance of lower cannula seal 25, causing lower cannula 24 to pierce the can, initiating liquid flow. Liquid is dispensed through the creamer plate 27 and nozzle 17 until the initial gas pressure reduces. This sequence can be achieved by a motorised embodiment, e.g. motors that independently drive cannulas 24 and 19.

The third step (iii) involves a continued downward force causing cannula 19 to pierce the (uppermost location) “base” of container B for the introduction of compressed air.

Particularly, the continued downward force overcomes resistance from the spring-loaded cylinder 29, thus cannula 19 pierces the can B introducing compressed air. The compressed air, activated upon puncture, increases gas pressure in the can to begin to dispense the remaining liquid.

When cannula 19 has passed through the wall of container B compressed air is introduced into the interior volume to mimic draught dispense in a conventional in-trade environment. The compressed air forces beverage from container B under pressure and through restrictor 27, causing foaming of the beverage as it is delivered to glass G. Since container B is a single serve volume compatible with the volume of glass G, the amount of serve is pre-set and does not need to be manually controlled by a user. In one form, the end of serve could be indicated by a sound of free air and no more liquid beverage emanating from nozzle 17 or the dispense operation may be intentionally halted while a small volume of beverage remains in the container, preventing ‘blowout’ and damage to the head in a delivery vessel. In either case the compressor pump is switched off and glass G is delivered to a consumer. A drip tray may catch any droplets of remaining beverage and the empty container B can be removed for disposal.

By way of example only, an operating pressure of approximately 1.5 bar has been found sufficient for test purposes, compared to approximately 2.5 bar required for keg operation (where beer must also be driven through a relatively long delivery line). The quoted pressure is at point of dispense but may be refined in future developments. Since there is no long delivery line carrying beverage for dispense, the control at point of dispense may be optimised and is more accurate for a consistent serve compared to a conventional keg system.

Returning to FIG. 2, beverage container B may be any volume, e.g. a 440 or 568 mL aluminium can volume, but likely with a “blank” can end suitable for being pierced for dispense, i.e. no pull tab. It is noteworthy that orientation of the beverage container (shown “inverted”) is arbitrary since suitable engaging features can be built into a new package design or retrofit into more conventional container shapes.

Compression and engagement features of the device are automated by use of at least one actuator, e.g. a linear actuators 31, preferably controlled by a processor/electronics housed within or separately from the main enclosure (not visible in FIG. 2). Closure 16 may be supplied as a reusable device with the main unit and, as mentioned, does not need to be a separate device attached to the container B in a factory.

It will be apparent from the operational method of the exemplary embodiment that a timed sequence of steps is required for most effective use. The timing of the sequence of piercing the can for dispense and introduction of compressed air can be achieved mechanically by a “weak” elastomer bushing 25 (or equivalent deformable structure) provided proximate the dispense nozzle 17 to create a liquid/airtight seal around piercing element 24 against container B as downward pressure is initiated.

A “strong” elastomer or spring-loaded bushing 22/33 at a cylinder housing 32 located proximate to the compressed air source/cannula 19 is provided to create an airtight seal at the top end of the device against container B. Spring-loaded cylinder 29 requires a stronger downward force to be deformed during compression compared to weak elastomer bushing 25 such that, in operation as described below, the weak bushing 32 gives way first under a compressive force to engage piercing element 24 into the downwardly oriented end of container B, while cannula 19 pierces the base of container B slightly thereafter.

With further reference to the first step (i) of FIG. 3 container B is inserted into the housing which includes supporting members holding each end (not illustrated) of the container and seated onto collar 23.

The second step (ii) involves activating a linear actuator 31 on top of the unit and piston 35, e.g. by an operator pressing an electrical switching button (not shown) to commence a dispense sequence, to engage and seal the strong elastomer bushing 33/spring-loaded cylinder 29 against container B while the weaker elastomer bushing 25 begins to compress causing piercing element 24 to pierce a downwardly oriented outlet end 16 of container B to initiate liquid flow through nozzle 17 into a glass. An initial slow flowing amount of beverage may drain from container B before the third step (iii) is reached, namely continued downward force causing compression of the strong seal 33 and engagement of cannula 19 to pierce the upwardly oriented end of container B while a compressor (not illustrated) is automatically activated to pump compressed air into the interior volume and in contact with the beverage, thereby actively forcing out beverage, through restrictor 27, into glass G.

While each step (ii) and (iii) could be instigated manually, it will be apparent that operation of the apparatus may more preferably be automated by electronic control means for improved repeatability of operation.

In other forms of the invention linear actuation of each cannula 24/19 may be automated by electronic means with separate actuator devices as an alternative to the mechanical solution of the strong and weak engagement portions.

The exemplary embodiment results in a filled secondary vessel (glass G) where a creamy head forms as a result of pressurised flow through restrictor 27. It is known in the art that head formation may be improved by a two-step dispense procedure which can be replicated by temporarily closing flow through nozzle 17 and allowing the poured liquid to settle if desired. Flow can be prevented/paused by activating a closure valve and/or deactivating the compressor and/or reversing air flow to cause a vacuum to counter-gravitational forces. A vacuum step enables greater control over paused dispense. In practical forms of the invention the vacuum step would be engaged for a defined time period and, if pour is not manually re-commenced, then the control system of the apparatus will automatically complete the pouring operation.

FIG. 4 illustrates a first supplementary operating sequence for pouring beverage into a glass G, in order to obtain a traditional creamy head, optionally occurring after the sequence of FIG. 3. The first supplementary sequence comprises three main steps, denoted by Roman numerals (iv), (v) and (vi). Particularly, at earlier step (i) or at least by step (iv) the system has detected a “keg” (i.e. unit container) and taken a temperature measurement to ensure it is in a desirable range. A manual handle (by way of example) has activated a motor to press down the container and pierce dispense end 16 of keg to relieve pressure as previously described. The uppermost end of keg was then pierced to introduce positive air pressure from a pump allowing beer to flow through the creamer plate. In one form, beer L flows based on predefined software settings.

At step (v) the pump stops, and a motor raises the uppermost cannula to vent can; in one particular form of the invention, at this step a vacuum (via a switch in the pump mode or by an additional vacuum pump) is applied to hold liquid from dispense while the beverage settles; a visual display may be provided to count down to a second pour. At step (vi), either automatically or by manual user intervention, the pump re-activates to restart flow at a lower pressure; pump pressure is gradually reduced before opening to atmospheric pressure to prevent blowout based on a pre-defined temperature/time table stored in a controller.

As mentioned, a display may provide a visual indicator and/or stepwise guidance to a user operating the device. Such guidance includes a prompt to insert or remove a container and timing information, pouring characteristics and temperature.

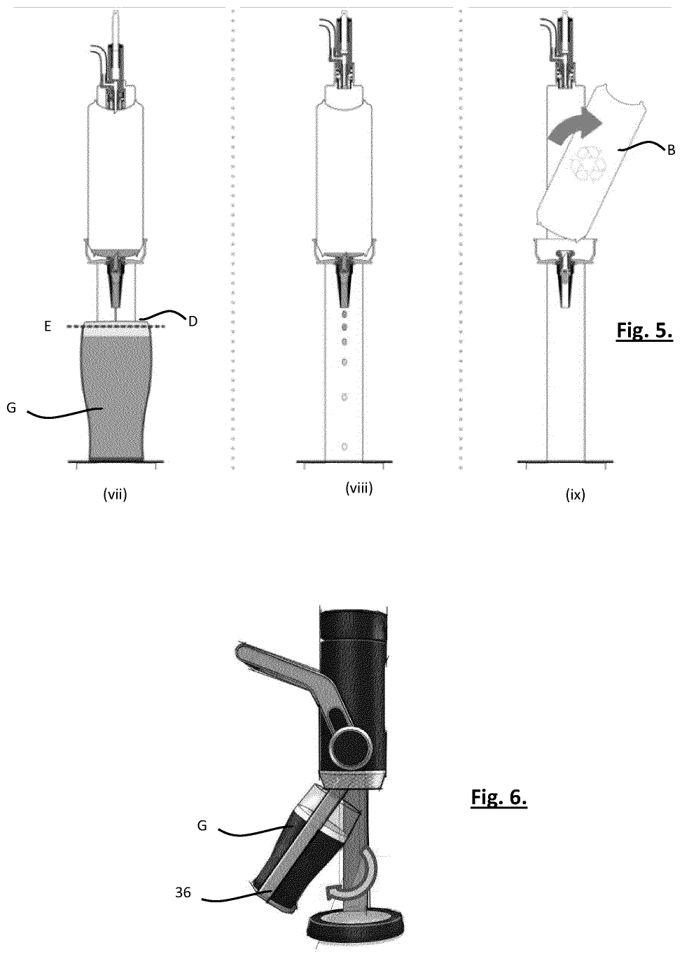

Referring to FIG. 5, illustrating the second supplemental sequence, at step (vii), a user manually (or via automatic means) stops pour when a liquid level reaches the bead E of the glass G; motor raises canula to vent can, allowing remaining liquid to flow under gravity to eliminate blowout; dome D (portion of head extending beyond opening of glass G) forms automatically; after a predefined time, cannula lowers and second vacuum step may be applied to stop liquid flow.

At step (viii), system informs user that process is complete, and that the beverage is ready to serve. User removes glass and serves to customer. At step (ix), after a pre-determined time, the cannula raises to vent the can again allowing any remaining liquid to drain. In one form, liquid drains through nozzle into a drip tray. A display may prompt a user to remove can for recycling. System resets.

From the foregoing it will be apparent that the delivery system mimics a two-part pour used in a bar to achieve a perfect head, required for stout beverages such as Guinness®.

In one refined form, the system delivers a first pour of over 80% of the liquid before shutting down/reversing pressure to leave a settling time. A second pour is then initiated by the user (e.g. by reference to a countdown clock) which delivers a final pour at lower pressure. It is notable that the user may be given control over when to engage the final pour, but they only have one chance to deliver the remaining liquid. If the pour ends early, it is preferable that they cannot reactivate, in order to avoid blowing air into the head.

FIG. 6 shows a rendering of a device according to the invention, including a tilting cradle 36 to provide an automated means of holding a glass G and mimicking the angled position of a glass held by a person during pouring. The tilting mechanism may be electronically controlled, or alternatively use springs and dampers to come upright as the glass is filled with liquid under gravity.

The control system preferably utilises an infrared sensor (e.g. aimed at a black can wall) to estimate temperature of the liquid within the aluminium can. Temperature data is then used to calculate timing of the pressurisation system for dispense.

Another aspect of note mentioned above is movement of the cannula at the top side of the inverted can in and out of the punctured aperture which controls/releases pressure within the can as needed and/or in combination with a vacuum.

The use of UV sterilisation within the apparatus may be implemented. UV sterilisation can involve a light being shone into the dispense nozzle when not in use (i.e. with an inverted can attached) to act as a germicidal means.

It is notable, according to the invention, that a lowermost portion of the inverted can is punctured first in order to release pressure so there is no spray-back of liquid at the top.

It is also notable that the specific steps executed by the firmware, including operating ranges etc., is a useful aspect of the invention. Therefore, the algorithm of steps and temperature-based control may form the basis of an independent invention.

It will be apparent that features from the embodiments described herein can be interchangeable or replaced by equivalent features without departing from the scope of the invention.

The method and apparatus according to the present invention as hereinbefore described is advantageous because it is simple to use and can be manufactured in a number of guises using available materials. Ideally the unit will be compact and fit comfortably into a commercial bar type of environment. It provides not only a practical benefit in that the appearance and taste of the beer is enhanced, but also a uniqueness by virtue of the process that may catch the attention of the consumer. A form of the invention may also be developed for home use.

The invention can be summarised as an apparatus, system and method for dispensing beverage from a single serve beverage package, e.g. an aluminium can B, particularly for the purpose of forming a head on the beverage poured from said package, although a key objective is to replicate draught dispense in a compact device, minimising cost and quality issues, to be deployed easily. In operation the sealed package B is located and held in a receiving enclosure 11 where, firstly, a dispense end of the package is opened by a piercing element 24 and, secondly, a gas is introduced under pressure at a second end through a hollow needle 19. Gas from a pump/compressor, into the internal volume of package B, is then used to drive beverage from the beverage package, e.g. through a restrictor structure 27 at the dispense end and into a drinking vessel G. The pump mode may then apply negative pressure to prevent beverage flow and enable a pause in flow or at completion of delivery to a vessel, thereby keeping a settled head of the beverage intact.

Use of a vacuum advantageously improves control of beverage delivery to prevent over filling and/or to implement a pause to allow a settle time. As such, an alternative expression of inventive concept considers a beverage dispense apparatus comprising: a receiving structure for locating a single serve beverage package between a dispense outlet and a gas delivery feature. Both the dispense outlet and gas delivery feature may include puncturing means to puncture the beverage package, but preferably a control aspect ensures the dispense outlet is opened by a puncturing means prior to insertion of the gas delivery feature. In use, gas is introduced under pressure into the beverage package, and into contact with a beverage contained therein, for a predetermined or activated time. In one particular form, a vacuum may be applied for a second predetermined or activated time to allow a pause in dispense for settle of beverage and/or to prevent overfilling. A vacuum is useful for countering gravity and breaking continuous flow of the beverage from its package.

An aspect of the invention can also be broadly described as a beverage dispense apparatus, comprising: a receiving structure for locating and holding a beverage package over a vessel to be filled; a dispense outlet, incorporating a piercing element configured for puncturing the beverage package and for enabling egress of beverage from the supported beverage package; and a gas delivery feature for, in use, puncturing a wall of the package and introducing a gas under pressure into the beverage package distant from an outlet end of the beverage package and into contact with a beverage contained therein; wherein the apparatus includes a control device configured for piercing/puncturing the outlet end of the package prior to piercing/puncturing introducing gas under pressure by the gas delivery feature.

1. A beverage dispense apparatus, comprising:
a receiving structure for locating and holding opposite ends of a beverage package;
a dispense outlet, incorporating a piercing element configured for puncturing the beverage package when held at opposite ends by the receiving structure; and
a gas delivery feature for, in use, introducing a gas under pressure into the beverage package distant from an outlet end of the beverage package and into contact with a beverage contained therein;
wherein the apparatus is configured for opening the outlet end of the package prior to introducing gas under pressure by the gas delivery feature.

2. The beverage dispense apparatus of claim 1, including a control means, wherein the control means controls an opening sequence of the outlet end prior to introducing gas under pressure.

3. The beverage dispense apparatus of claim 1, including at least one pump operable in a vacuum mode for pausing dispense.

4. The beverage dispense apparatus of claim 1, wherein the piercing element is hollow such that, in use, egress of liquid is through the hollow piercing element.

5. The beverage dispense apparatus of any preceding claim 1, wherein the gas delivery feature includes a puncturing device configured for piercing a wall of the package.

6. The beverage dispense apparatus of claim 5, wherein the puncturing device is a cannula configured for, in use, delivery of gas under pressure into package.

7. The beverage dispense apparatus of claim 1, wherein the receiving structure includes an upper portion, proximate the gas delivery feature, for receiving an upper edge of the beverage package end and a lower portion, proximate the dispense outlet, for receiving a lower edge of the beverage package.

8. The beverage dispense apparatus of claim 2, wherein the control means is configured to control a duration of activation of the gas delivery feature and egress of beverage through the dispense outlet.

9. The beverage dispense apparatus of claim 1, wherein the receiving structure includes an engagement surface associated with the gas delivery feature for engaging with an end of the beverage package.

10. The beverage dispense apparatus of claim 1, wherein the dispense outlet incorporates a restrictor plate.

11. The beverage dispense apparatus of claim 1, in combination with a beverage package, wherein the dispense outlet is incorporated with the beverage package.

12. The beverage dispense apparatus of claim 1, wherein the receiving structure is configured for locating and holding the beverage package over a vessel to be filled.

13. The beverage dispense apparatus of claim 2, wherein the control means includes a first deformable bush for sealing against a downwardly oriented end of the package and a second deformable bush for sealing against an upwardly oriented end of the package, wherein the first deformable bush has a lower resistance to compression compared to the second deformable bush.

14. The beverage dispense apparatus of claim 13, wherein the gas delivery feature includes a puncturing device configured for piercing a wall of the package, the second deformable bush surrounding said puncturing device, while the first deformable bush surrounds the piercing element of the dispense outlet.

15. The beverage dispense apparatus of claim 13, wherein the second deformable bush includes a resiliently mounted cylinder, extending coaxially from a piston.

16. The beverage dispense apparatus of claim 15, wherein the piston is moveable toward the package and the resiliently mounted cylinder translates compressive force to the package to firstly accomplish the open communication from the dispense outlet and secondly accomplish delivery of gas into an internal volume of the package.

17. (canceled)

18. A method of dispensing beverage from a beverage package, including the sequential steps of:
locating and holding a sealed beverage package by each end in a receiving device;
opening a dispense end of the beverage package;
introducing a gas under pressure to the beverage package and into contact with the beverage therein at a location distant from the dispense end;
dispensing beverage from the beverage package, through the open dispense end, into a vessel.

19. The method of dispensing beverage from a beverage package according to claim 18, wherein opening the dispense end is by way of a piercing element.

20. (canceled)

21. The method of dispensing beverage from a beverage package according to claim 17, wherein a dispense flow rate is controlled by gas flow rate, optionally including use of a vacuum to pause or stop flow.

22. The method of dispensing beverage from a beverage package according to claim 17, wherein beverage is directed through a restrictor plate associated with the dispense end.

23. (canceled)

24. (canceled)

25. (canceled)

26. (canceled)
